(19) United States
(12) Patent Application Publication
(10) Pub. No.: US 2008/0143140 A1
(43) Pub. Date: Jun. 19, 2008

(54) Hatch for a Commercial Vehicle

(75) Inventors: Edvard Bang, Vastra Frolunda (SE); Maja Stalrud, Goteborg (SE)

Correspondence Address: WRB-IP LLP, 1217 KING STREET, ALEXANDRIA, VA, 22314, US

(73) Assignee: VOLVO LASTVAGNAR AB, Göteborg (SE)

(21) Appl. No.: 11/816,418

(22) PCT Filed: Mar. 10, 2005
(86) PCT No.: PCT/SE05/00355

§ 371 Date: Aug. 16, 2007

(51) Int. Cl. B60J 5/00; B62D 25/12

(52) U.S. Cl. 296/152

(57) ABSTRACT

A hatch for a commercial vehicle includes an outer panel having an inner surface, at least one rail being provided at the inner surface, the rail enabling attachment of designated articles at optional positions along the length of the rail.

### BACKGROUND AND SUMMARY

The invention relates to a hatch for a commercial vehicle, comprising an outer panel having an inner surface.

The present invention refers to the field of commercial vehicles, such as trucks, lorries or busses. The driver's cabs of commercial vehicles may include a number of doors or hatches, e.g. an engine compartment hatch, a side hatch to a luggage space, and an entrance door to the cab.

The hatches are normally mounted to the cab of the vehicle via suitable hinges being arranged on the inside of the hatch. To assist opening or closing of the hatch, gas springs may be provided next to the hinges. Further, different types of locks or handles are often mounted to the hatch. Some types of hatches may additionally be provided with articles for performing specific functions depending on the location and function of the hatch. This is particularly the case for engine compartment hatches, which may be provided with diverse articles such as e.g. recirculation shields, bug nets, or signs apart from the already mentioned hinges, gas springs, locks and handles.

Thus, there exists a need for mounting a number of different articles such as hinges, locks, shields etc to the various hatches of a driver's cab.

Today, hatches as mentioned above normally comprises an outer panel which forms the outer surface of the hatch, and an inner panel being attached to the outer panel and forming the inner surface of the hatch.

The inner panel serves as a fastening surface for articles such as those mentioned above. Accordingly, articles may be fastened to the inner panel using different fastening methods such as bolting or welding, without risking impairment of the outer appearance of the outer panel. Further, the inner panel functions so as to support or stiffen the outer panel, such that the hatch obtains the necessary strength and stiffness to withstand the strains of everyday use.

For assembling a hatch as described above, the inner panel must first be mounted to the outer panel, whereafter diverse articles may be attached to the inner panel using different consoles, bolts, wedging etc. This is a relatively cumbersome and time-consuming procedure.

It is desirable to provide a hatch for a commercial vehicle, whose assembly may be facilitated in relation to the assembly of prior art hatches.

According to an aspect of the present invention, a hatch for a commercial vehicle comprises an outer panel having an inner surface, wherein said inner surface is provided with at least one rail enabling attachment of designated articles at optional positions along the length of the rail.

According an aspect of the invention, a rail is attached directly to the inner surface of the outer panel. The rail serves as a fastening area for designated articles such as e.g. hinges, automatic springs, locks, handles, recirculation shields, bug nets etc. Further, the rail will add to the stiffness of the hatch.

Thus, a suitable arrangement of the rail or rails results in that no inner panel is necessary in a hatch according to the invention. Without inner panel, the weight of the panel may be considerably reduced, which is highly advantageous in any engine-driven vehicle. Further, the consumption of material for the hatch is reduced and the assembly of the hatch may be facilitated, both of which contribute to diminished expense for the total hatch.

The rail may preferably extend along at least 50%, preferably at least 75%, most preferred at least 90% of the hatch's extension along the direction of the rail. A longer rail will give a wider range of optional positions for attachment of articles. Also, the stabilising effect of the rail is enhanced with a longer rail.

In an aspect of the invention, the hatch may have at least two rails provided at said inner surface, said rails extending substantially in parallel.

In an aspect of the invention, the hatch has a first pair of rails extending substantially in parallel, and a second pair of rails extending substantially in parallel and transverse to said first pair of rails. This arrangement of the rails is particularly useful for an engine hatch, where the rails may be arranged so as to form a frame surrounding an air inlet portion of the outer panel. Further, the square configuration of the rails is particularly suitable for providing the hatch with the desired stability or stiffness. In addition, the square configuration of rails provides a great variety of fastening possibilities for designated articles.

Mounting of articles to a rail may be performed by any known means such as by bolting, clamping or welding. The rail may advantageously have attachment means extending along the rail for enabling attachment of designated articles at an optional position along the attachment means. Such an attachment means could be e.g. a list or rim to which articles may be fastened.

However, an aspect of the invention, the attachment means enables releasable attachment of designated articles. With such attachment means, the articles may easily be removed or replaced, without causing alteration or damage to the hatch or rail.

The attachment means may preferably be formed integral with the rail. Thus, the attachment means forms part of the rail itself.

Releasable attachment may be accomplished by the attachment means forming a male/female connection to fit with a female/male connection, respectively of the designated article.

Preferably, the attachment means may comprise a groove extending along the rail.

In one aspect, the groove, as seen in cross-section, defines an inner portion for receiving a counteracting element for fastening of an article, and an outer portion being narrower than said inner portion, so as to from a stop for extraction of a counteracting element received in the inner portion in a direction transverse to the length of the rail. This embodiment enables convenient releasable connection of articles to the rail. As an example, articles may be attached to the attachment means using a bolt and a counter-acting element, such as a nut plate. The counter acting element may be inserted in the inner portion of the groove from a short end of the groove or from an insertion opening being provided along the groove, and slid in the inner portion to reach a desired position for fastening an article. Once in place, a bolt being associated with the article may be brought through the narrow outer portion of the groove to engage to the counter element so as to fasten the article.

In addition to the inner and outer portion of the groove described above, the groove may further define an outermost portion being wider than the outer portion, so as to form a guide portion for receiving guide means of a designated article.

Such a guide portion could act as sole attachment means for a compressible element being introduced into the guide portion and retained by friction. Such an attachment would however only be suitable for attachment of relatively small or light articles, being exposed only to moderate forces.

When an article is attached using the inner and outer portion of the groove as described above, the guide portion may act to guide the article for attachment, and to stabilize the article once attached.

A groove having the above-mentioned outer and inner portions, and a wider outermost portion may thus provide for two different attachment possibilities: by bolts or the like using a counter-element in the inner portion of the groove or by friction, using the outermost portion of the groove for receiving a compressible element. In addition, articles may be clamped about the rail using suitable brackets or the like

The friction function of a guide groove may naturally also be obtained if the rail defines a separate guide groove, without any outer and inner portions for counter-acting elements.

Further, articles may be attached by clamping about the rail, in which case the groove may be used to provide additional support for a clamping bracket or the like.

The inner and outer portions may advantageously be provided by a groove having a T-shaped cross-section. The wider guide portion may be provided by a groove having a C-shaped cross-section.

### BRIEF DESCRIPTION OF THE ACCOMPANYING DRAWINGS

Other features and advantages of the present invention will appear more clearly from the following description of exemplary embodiments, wherein

FIG. 1 illustrates schematically an embodiment of a hatch according to the invention of a commercial vehicle comprising a rail system.

FIG. 2 illustrates an embodiment of a cross-section of a rail of the hatch in FIG. 1.

FIG. 3 illustrates an example of fastening of articles to the rail of FIG. 2.

FIG. 4 illustrates another example of fastening of articles to the rail of FIG. 2.

FIG. 5 illustrates an embodiment of a rail where the attachment means comprises a row of individual attachment formations.

### DETAILED DESCRIPTION

Features and advantages of the invention will now be described in relation with an exemplary embodiment.

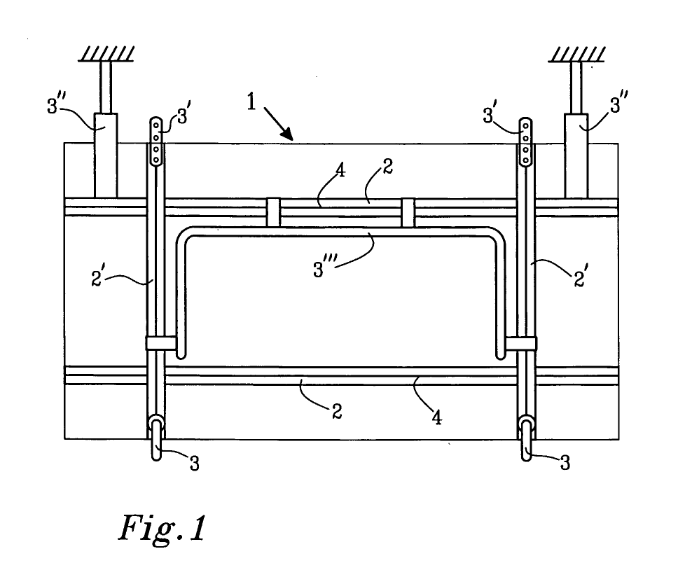

FIG. 1 illustrates schematically an embodiment of a hatch 1 of a commercial vehicle, in this case an engine compartment hatch. The hatch comprises an outer panel 11, whose outer surface forms the exterior of the hatch. In FIG. 1, the outer panel 11 is directed with its inner surface facing a viewer.

The inner surface of the outer panel 11 is provided with a number of rails 2, 2′ at which designated articles 3 are attached. The designated articles are exemplified by schematically indicated pairs of hinges 3′, gas springs 3″, locks 3 and an air distribution shield 3′″. It is readily understood that other articles could be attached to the outer panel 11 via the rails 2, 2′.

In the illustrated embodiment, the hatch has a first pair of rails 2 extending substantially in parallel to each other, and a second pair of rails 2′ extending substantially in parallel to each other and transverse to said first pair of rails. The first pair of rails 2 extends in a horizontal direction across the panel 11, and the second pair of rails 2′ extends in a vertical direction across the panel 11. Accordingly, the pairs of rails 2, 2′ provide the panel 11 with enhanced stability, while at the same time providing numerous possibilities for attachment of articles 3.

In this embodiment, the rails 2, 2′ extend along essentially the full length of the hatch's extension in the respective directions of the rail.

The rails 2, 2′ are all provided with similar attachment means 4 enabling releasable attachment of designated articles 3 along the attachment means 4. Thus, the articles 3 may be attached, removed, replaced or reattached to any one of the rails 2, 2′.

In this case, the attachment means 4 extends along substantially the entire length of a rail 2. However, it is possible to provide rails 2 where the attachment means 4 extends along only a part of the rail length. Nevertheless, it is naturally preferred that the attachment means extends along a substantial part of the rail so as to enable attachment along the majority of its length, and preferably along substantially the full length thereof.

The attachment means 4 of FIG. 1 provides for releasable attachment of articles by mechanical interlocking, where the attachment means forms a female connection to fit with a male connection of a designated article or an intermediary fastening device for fastening a designated article.

As seen in FIG. 1, the attachment means 4 is formed by a groove extending along the rail. The groove provides a continuous attachment means, allowing for stepless positioning of articles.

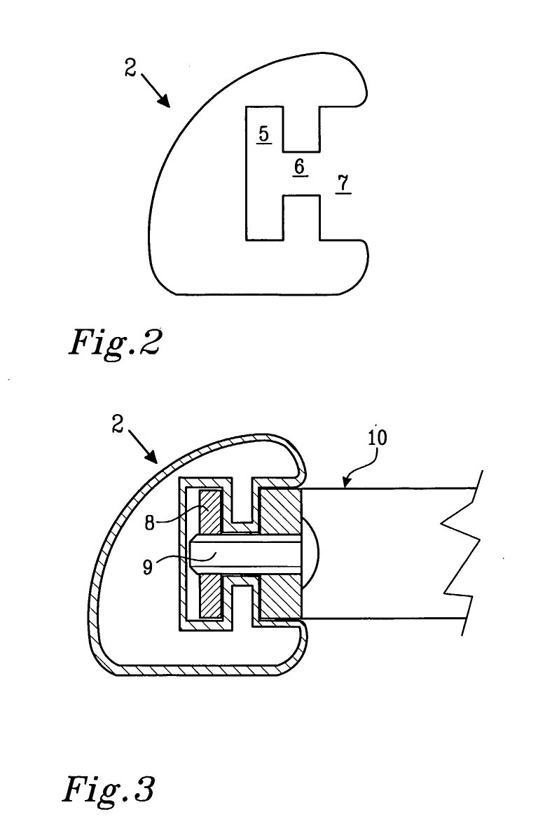

FIG. 2 illustrates the cross-section of the embodiment of a rail 2 illustrated in FIG. 2. The groove 4 defines an inner portion 5 and an outer portion 6, being narrower than the inner portion in a direction perpendicular to the length of the rail. The inner portion is adapted to receive a counteracting element for fastening of an article, and the outer portion 6 is narrower than the inner portion 5 so as to form a stop for extraction of such a counteracting element received in the inner portion in a direction transverse to the length of the rail.

Further, the groove 4 defines in this case an outermost portion 7 being wider than the outer portion 6. This purpose of the outermost portion 7 of the groove is to form a guide portion for receiving guide means of a designated article or a fastening device for such an article.

As seen in FIG. 2, the inner portion 5 and the outer portion 6 of the groove forms the shape of a T where the base of the T is directed towards the opening of the groove. The outermost portion 7 forms the shape of a C with its opening defining the outermost opening of the groove. Thus the groove 4 has a relatively wide inner portion 5, a relatively narrow outer portion 6, and widens again to an outermost portion 7, in this case being just as wide as the inner portion 5.

In the illustrated embodiment, the end of the rail 2 opposing the groove 4 has a rounded shape, which is advantageous from an esthetical and practical point of view. However, numerous other shapes may naturally be envisaged.

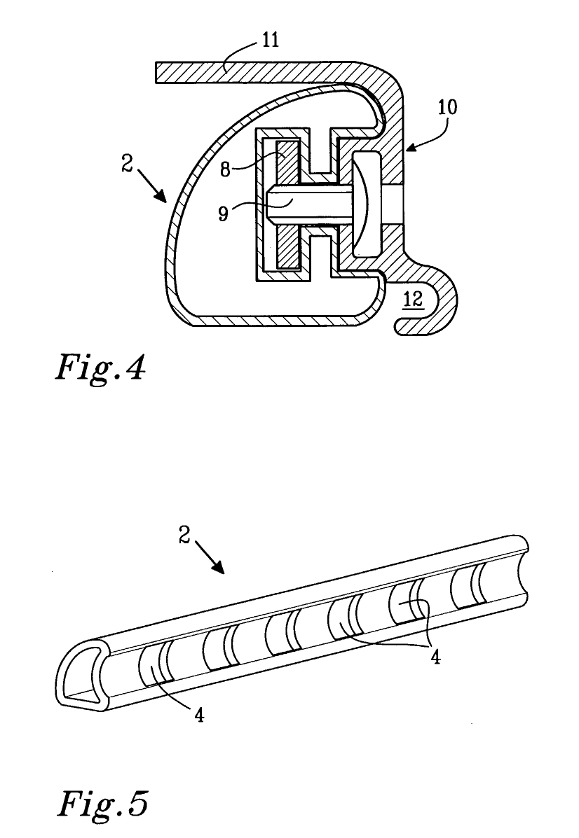

FIGS. 3 and 4 are illustrative examples showing how fastening of articles to a rail as described in FIGS. 2 and 3 may be accomplished.

FIG. 3 shows schematically how fastening is performed using the T-shaped inner portion 5 and 6 of the groove 4.

A counter-acting element 8 is received in the inner portion 5 of the groove 4, and is engageable by a fastening element 9, such as a bolt, to fasten an article, either directly or via a fastening console 10.

The counter-acting element 8 could be inserted before mounting of the rail 2, via one of the open short ends thereof. Alternatively, openings or lids could be provided at one or more specific locations along the groove 4, where the narrower outer portion 6 is widened so as to enable introduction of a counteracting element 8 into the groove.

Counteracting elements could be introduced in a number corresponding to the needs for fastening a previewed number of articles. Thus, the function, form and size of each counteracting element may be selected to match the specific article.

However, it could be advantageous to introduce an optional number of counteracting elements 8 into the groove 4 e.g. before mounting the rail 2, so as to provide a number of fastening possibilities, where the user might choose to make use of all or only some thereof. Also, one counteracting element could include a number of fastening positions, i.e. the counteracting element could form a strip in which a number of holes are provided for receiving fastening elements 9.

In another embodiment, the counteracting element 8 may have an elongate shape, so as have a width being less than the width of the narrower portion 6 of the groove 4, and a length exceeding the width of the narrower portion 6 of the groove 4. Such a counter-acting element may be directed along the groove 4 for introduction to the inner portion 5 into via the narrower portion 6 of the groove 4. Once in place in the inner portion 5, the elongate counteracting element may be pivoted, preferably 90 degrees, such that its longest extension forms a stop for withdrawal of the counteracting element via the groove 6.

In yet another embodiment, the groove may be provided with friction means for enhancing the friction between a counteracting element received in the groove and the walls of the groove so as to retain the counteracting element in position in the groove. Such friction means could for example comprise protrusions or indentations formed along inner walls of the groove.

The counter-acting elements 8 may advantageously have a form corresponding to the inner portion 5 of the groove 4 so as to be slidable therein. Thus, any counter-acting element 8 received in the inner portion 5 of the groove may be slid to an optional position for fastening an article.

It is understood that the fastening of an article in the above-mentioned manner may be made at an optional position along the attachment means 4. The fastening does not cause any alteration or damage, such as e.g. bore holes, of the rail 2. Instead, the articles are releasably attached such that they may be attached, removed and reattached at optional positions of the rail.

In FIG. 3, it is seen how a portion of an article or fastening device 10 extends into the outermost guide portion 7 of the groove 4. Thus the outermost portion 7 serves to guide the fastening device 10 and to enhance its stability. Further, the head of the fastening means 9, in this case a bolt, may be confined to the space within the outermost portion 7 of the groove 4. Thus, bolt heads or the like protruding from the rail 2 may avoided.

FIG. 4 illustrates an alternative embodiment for fastening of an article to a rail 2 as depicted in FIG. 2. In this case, a bracket 11 is attached to the rail 2 in a similar manner as the fastening portion 10 of FIG. 3. The bracket 11 forms space 12 between the bracket and the outer surface of the rail 2, in this case at a position adjacent to the groove 4. Such a space 12 may be used e.g. for accommodating cables or the like that might be associated to the article to be mounted. In addition, the bracket 11 forms a platform 13 with a flat surface extending over the rail 2, enabling fastening of articles 2 to a position on the platform 13. Naturally numerous forms of brackets 11 may be envisaged for fastening different types of articles.

Further, brackets may be designed to be clamped about the rail 2, preferably using at least the outermost portion 7 of the groove 4 to provide additional support for the bracket. In this case, no counteracting elements or fastening elements are needed. However, generally, attachment using counteracting elements and fastening elements may be made more stable and convenient that attachment by clamping. Nevertheless, a rail providing double attachment possibilities: fastening element/counteracting element or clamping, will provide the user with numerous options for fastening of different types of articles to the rails.

FIG. 5 depicts an alternative embodiment of a rail 2 having attachment means 4 extending along the length of the rail, wherein the attachment means 4 is formed by a number of discrete attachment formations 16 being arranged sequentially along the rail. Each attachment formation 16 provides a position for attachment of an article to the rail. In this case, the attachment formations 16 forms indentations in the rail 2, to which articles may be attached. The indentations 16 may advantageously have a cross-section similar to those described above, being suitable for receiving a counteracting element. Alternatively, the indentations 16 may be shaped so as to receive a fastening element such as a bolt. This embodiment is however not as flexible for fastening of different types of devices using different attachment means as embodiments where a counteracting element may be selected for each different case. Further, the embodiments using discrete attachment formations do naturally not exhibit the advantage of stepless adjustment of the position of the articles.

The rails may be made by any suitable material, such as e.g. aluminium, steel or plastic, depending on the type of hatch and of the articles to be attached. The rails may be mounted to the outer hatch panel using any suitable method, e.g. by fastening means such as bolts by welding, glueing or folding.

In the above, the invention has been described in relation to an exemplary embodiment. It is understood that numerous alternative embodiments are possible. The cross-section of the rails 2 may be varied in many different manners so as to accomplish functional attachment means extending along the length of the rails. Fastening means or brackets for use with the rails may have various shapes and sizes, as long as they correspond to the attachment means of the rail. The configuration of the rails on the hatch as well as the configuration of the articles on the rails may be varied in accordance with a specific hatch situation.

A person skilled in the art will readily be able to select a rail of a suitable material whose length, width and other properties are sufficient to stabilise a particular hatch.

1. Hatch for a commercial vehicle, comprising an outer panel having an inner surface, the inner surface being provided with at least one rail enabling attachment of designated articles at optional positions along a length of the rail, the rail being provided with attachment means extending along the rail for enabling attachment of designated articles, the attachment means comprising a groove extending along the rail, and the groove, as seen in cross-section, defining an inner portion for receiving a counteracting element for fastening of a designated article, and an outer portion being narrower than the inner portion, so as to form a stop for extraction of the counteracting element when received in the inner portion in a direction transverse to the length of the rail, and wherein the groove further defines an outermost portion wider than the outer portion so as to form a guide portion for receiving guide means of a designated article.

2. Hatch according to claim 1, wherein the rail extends along at least 50% of an extension of the hatch in a longitudinal direction of the rail.

3. Hatch according to claim 2, wherein the rail extends along a full length of the hatch's extension in the longitudinal direction of the rail.

4. Hatch according to claim 1, wherein the hatch has at least two rails provided at the inner surface, the rails extending substantially parallel.

5. Hatch according to claim 4, wherein the hatch has a first pair of rails extending substantially parallel to each other, and a second pair of rails extending substantially parallel to each other and transverse to the first pair of rails.

6. Hatch according to claim 1, wherein the attachment means enables releasable attachment of designated articles.

7. Hatch according to claim 1, wherein the attachment means forms a male/female connection to fit with a female/male connection, respectively, of the designated article.

8. Hatch according to claim 1, wherein the hatch is an engine compartment hatch.

9. Hatch according to claim 1, wherein at least one designated article is attached to the rail.

10. Hatch for a commercial vehicle, comprising an outer panel having an inner surface, the inner surface being provided with at least one rail enabling attachment of designated articles at optional positions along a length of the rail, the rail being provided with attachment means extending along the rail for enabling attachment of designated articles, wherein the attachment means comprising a groove extending along the rail, and the groove further defining an outermost portion wider than the outer portion so as to form a guide portion for receiving guide means of a designated article, the hatch having a first pair of rails extending substantially parallel to each other, and a second pair of rails extending substantially parallel to each other and transverse to the first pair of rails, such that the pairs of rails form a square configuration where intersections of one parallel pair of rails with the other parallel pair of rails are located within an outer periphery of the inner surface of the outer panel.

11. Hatch according to claim 10, wherein the rail extends along at least 50% of an extension of the hatch in a direction of the rail.

12. Hatch according to claim 11, wherein the rail extends along a full length of the hatch's extension in the direction of the rail.

13. Hatch according to claim 10, wherein the rail is provided with attachment means extending along the rail for enabling attachment of designated articles at an optional position along the attachment means.

14. Hatch according to claim 13, wherein the attachment means enables releasable attachment of designated articles.

15. Hatch according to claim 14, wherein the attachment means forms a male/female connection to fit with a female/male connection, respectively of the designated article.

16. Hatch according to claim 15, wherein the attachment means comprises a groove extending along the rail.

17. Hatch according to claim 15, wherein the groove, as seen in cross-section, defines an inner portion for receiving a counteracting element for fastening of an article, and an outer portion being narrower than the inner portion, so as to form a stop for extraction of the counteracting element when received in the inner portion in a direction transverse to a length of the rail.

18. Hatch according to claim 10, wherein the hatch is an engine compartment hatch.

19. Hatch according to claim 10, wherein at least one designated article is attached to the rail.
